(19) United States
(12) Patent Application Publication
(10) Pub. No.: US 2013/0299627 A1
(43) Pub. Date: Nov. 14, 2013

(54) Low speed, high performance hang glider

(71) Applicant: Richard Boone, Wichita, KS (US)

(72) Inventor: Richard Boone, Wichita, KS (US)

(21) Appl. No.: 13/986,285

(22) Filed: Apr. 19, 2013

Related U.S. Application Data
(60) Provisional application No. 61/688,134, filed on May 9, 2012.

(51) Int. Cl. B64C 31/028

(52) U.S. Cl. CPC B64C 31/028
USPC 244/16

(57) ABSTRACT

Sail deflection, from large resultant moments, creates excess aerodynamic twist and limits hang glider performance. Incorporating a rear spar and sail attachment system, as a design feature, allows control and definition of this critical performance component. Hang gliders with this design feature will produce more total lift which in turn will produce lower stall speeds and less drag.

### CROSS-REFERENCE TO RELATED APPLICATIONS

This application claims priority to U.S. Provisional Patent Ser. No. 61/688,134 filed 8 May 2012 and incorporated herein by reference

### FIELD

Low speed aircraft

[symbol]

### BACKGROUND

A hang glider is a light foot-launchable aircraft on which the pilot is typically suspended below the wing. The Delta or “Rogallo” style hang gliders are made of a lightweight framework covered by a fabric wing. Control is often performed by shifting body weight in relationship to the aircraft. The act of flying a hang glider is “Hang Gliding” and is one of the purest and most rewarding forms of flight. Being able to pilot hang gliders requires defined locations, specific equipment and training by qualified instructors. Typical hang glider launch speeds and/or poor glide performance drive training to topographical requirements of steep hills, soft unobstructed terrain, and favorable winds.

All aircraft other than “lighter than aircraft” (balloons, round parachutes, etc.) requires forward velocity or air speed to create the “Lift” needed to support the combined weight of the aircraft and pilot. This forward movement through the air also creates “Drag” or air resistance to the forward movement.

Gliders do not have thrust generating power systems and absence of other forms of power to counteract the glider's drag, are always descending or losing altitude during gliding flight. This drag combined with the lift generated by the glider, moving through the air, defines the gliders “glide angle” or the ratio of the glider's horizontal travel as compared to the glider's loss of altitude or descending in the vertical plane. The typical low glide angles of hang gliders requires training to be performed on hills steep enough to allow the pilot to get the flying speed and with a slope greater than the glide angle of the aircraft.

Individuals who wish to learn/experience hang gliding must live within a short driving distance from training hill, with established operations, gliders and instructors, or willing to except the commitment of travel expense and possible unsuitable weather conditions.

Once taught, pilots continue to need access to hills or mountains of suitable height, steepness, with unobstructed terrain at launch and landing, favorable winds, and path/road access to both the top and bottom.

Hang gliding requires physical strength to hold the glider at launch and control during flight. It also requires the ability to quickly accelerate to take-off speeds in short distances, which often require a steep incline, and to run fast enough to land safely.

Current low speed hang gliders have very large sail areas. These gliders are poor performing related to other gliders and are often limited in the conditions which can be safely flown.

### SUMMARY

A hang glider with lower stall speed and yet offer good glide performance would require less physical ability and greatly expand the potential number of hill/mountains suitable for flying. The glider per this claim incorporates a new airframe where the typical cross-bar operates in a fashion more typical to a “rear spar”. This configuration limits the sail deflection which allows for a larger portion of the airfoil to operate at higher lift angles of attack. This increases the glider's ability to generate higher lift loads yielding lower stall speeds.

This author has incorporated this feature on several prior hang glider designs, though these earlier designs were intended to be higher performance platforms and not optimized for low speeds thus preventing fulfillment of issues addressed by this claim.

This combination of low speed and high performance is suitable to training operations and allow training to be performed at lower risks and at vastly more locations. With help from a support staff, a glider per this claim can be used to train pilots of limited physical ability including small children and individual restricted to wheel chairs.

Achievement of slow “take-off” speed or the speed needed to create the lift required the support the pilot's/glider weight may allow hills or mountains with much shallower slopes to be utilized.

Slow “take-off” speed gliders maybe applicable for use with hang gliders with engines and propellers and/or support towed flight.

### BRIEF DESCRIPTION OF THE DRAWINGS

FIG. 1 Isometric view of a conventional hang glider including; the outline of fabric covering (Sail) and airframe components.

FIG. 2 Vertical sectional view of a conventional hang glider with arrows representing flight loads, resultant moments and deflection of the sail.

FIG. 3 3-view sketch of conventional hang glider showing typical deflection of the trailing edge.

FIG. 4 Isometric view of hang glider, per this claim including; the outline of fabric covering (Sail), airframe components with Rear Spar replacing Cross Bar Compression Strut and Drag Wire.

FIG. 5 Vertical sectional view of a hang glider, per this claim, with arrows representing flight loads and showing how the deflection is controlled by the Rear Spar.

FIG. 6 3-view sketch of a hang glider, per this claim, showing reduced deflection of the trailing edge.

### DETAIL DESCRIPTION OF THE EMBODIMENTS

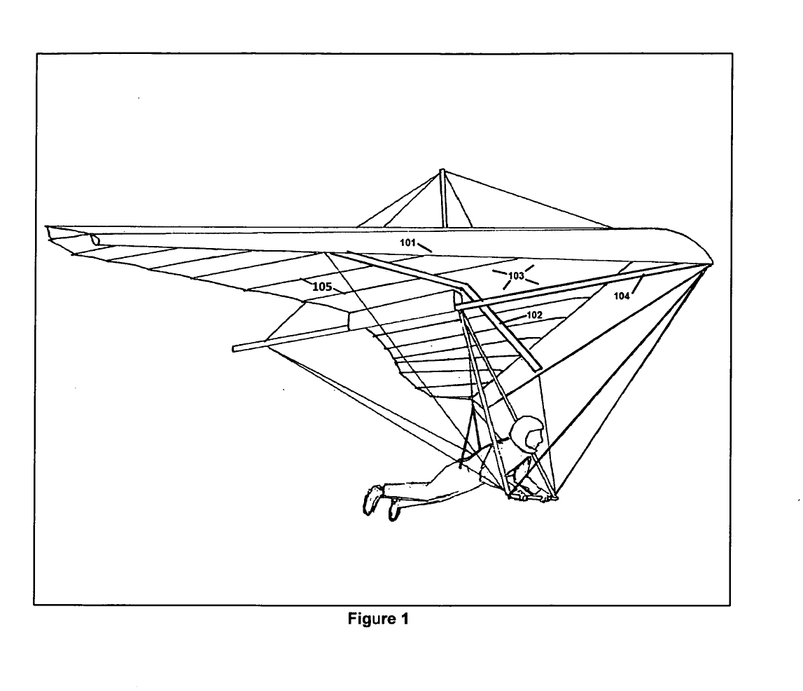

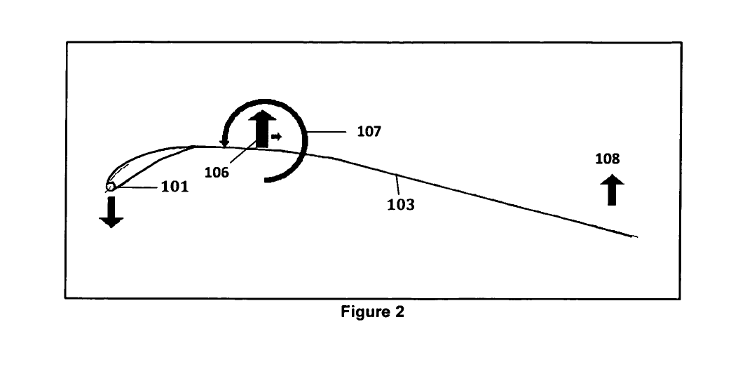

FIG. 1 illustrates the plan form of the typical hang glider with tubular Leading Edges 101 and tubular Keel 104 being held at a defined distance or angle by tubular Cross Bar 102. The Sail 103 bellows between Leading Edge 101 and Keel 104. Vertical lines on sail represent typical Batten 105 (sail stiffening) spacing. The center Batten that shapes the Sail 103 defines the center airfoil cross-section as depicted in FIG. 2.

FIG. 2 is a detailed view of the cross-section shown in FIG. 1 and defines the Resultant Loading 106 created by flight loads on any given section of Sail 103 and the Resultant Moment 107 created by support by Leading Edge 101. The resultant moment around Leading Edge 101 is defined as Sail Deflection 108 or pushing the rear of the sail 103 upward. This deflection reduces maximum potential lift by lowering the angle of the lifting section. This deflection also increases the drag.

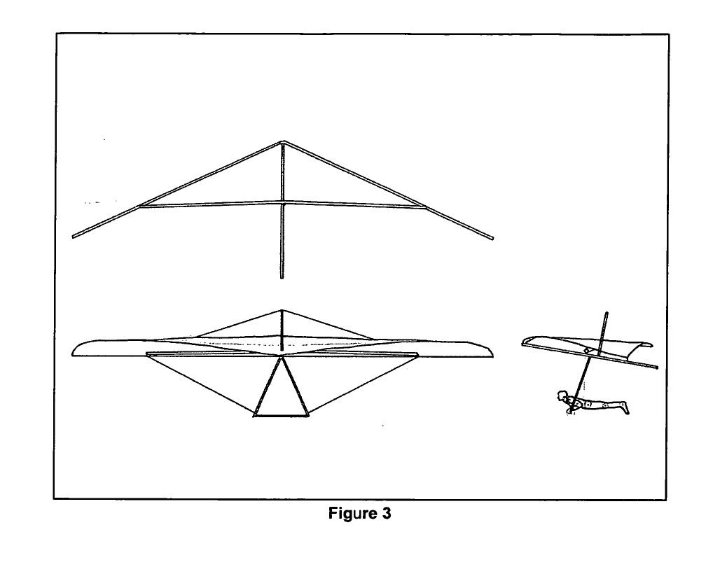

FIG. 3 illustration of 3 view of a typical hang glider showing the resultant trailing edge deflection. Sail has been removed in top view for clarification.

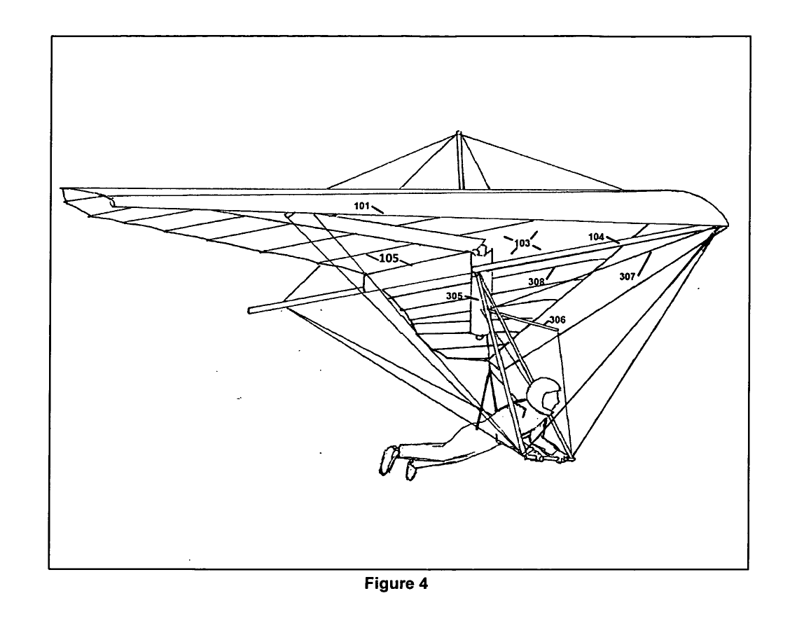

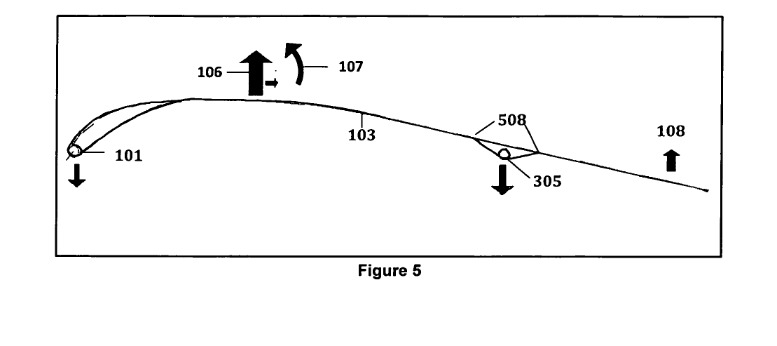

FIG. 4 illustrates the plan form of a hang glider, per this claim. The Cross Bar 102 (FIG. 2) is replaced with a Rear Spar 305, Compression Strut 306 and Drag Wire 307. The Sail 103 bellows between Leading Edge 101 and Keel 104. Vertical lines on sail represent typical Batten 105 (sail stiffening) spacing. The center Batten that shapes the Sail 103 defines the center airfoil cross-section as depicted in FIG. 5.

FIG. 5 is a detailed view of the cross-section shown in FIG. 4 and defines the Resultant Load 106 created by flight loads on any given section of Sail 103 and support by Leading Edge 101. As seen by this illustration, the Resultant Moment 107 around Leading Edge 101 is reduced by the Rear Spar 305 with Spar Attachment(s) 508.

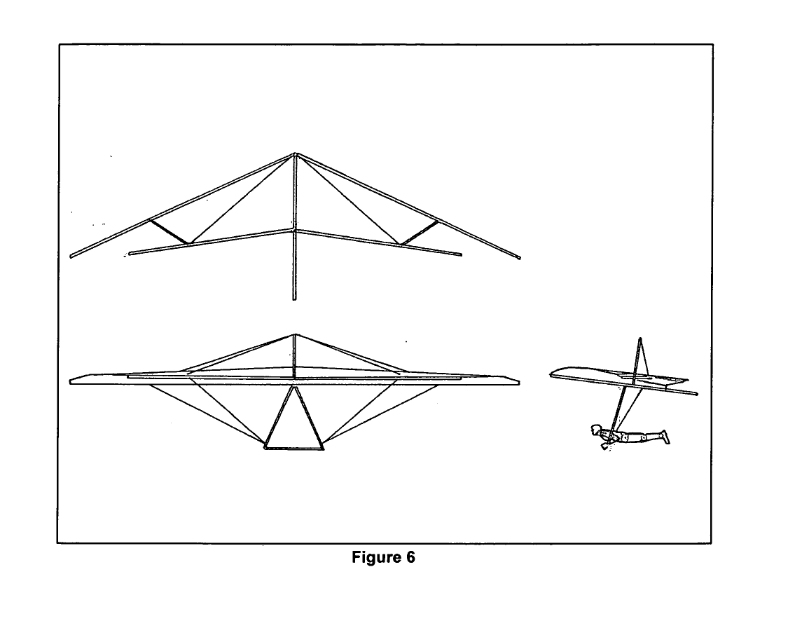

FIG. 6 illustration of 3 view of a hang glider, per this claim, showing the controlled trailing edge deflection. Sail has been removed in top view for clarification.

What is claimed is:

1. Replacing the conventional “Cross Bar” with a “Rear Spar” and Sail Attachment System, per this claim, provides an effective method to control performance limiting aerodynamic twist on hang gliders.

2. Lower aerodynamic twist, created by the incorporation of a rear spar and rear spar sail attachment, increases the potential for lift, which in turn lowers the stall speed.

3. Lower aerodynamic twist, created by the incorporation of a rear spar and rear spar sail attachment, reduces drag which, for any effective lift, increases glider performance.
